(19) United States
(12) Patent Application Publication
(10) Pub. No.: US 2012/0282151 A1
(43) Pub. Date: Nov. 8, 2012

(54) REACTOR FOR REMOVAL OF HYDROGEN FROM A LIQUID ORGANIC CARRIER

(76) Inventors: David O'Connor, North Bend, WA (US); Esmaeel Naeemi, Lynnwood, WA (US)

(21) Appl. No.: 13/442,739

(22) Filed: Apr. 9, 2012

Related U.S. Application Data
(60) Provisional application No. 61/472,990, filed on Apr. 7, 2011.

(51) Int. Cl. B01J 8/02

(52) U.S. Cl. 422/199

(57) ABSTRACT

The current application is directed to a packed-bed reactor comprising a housing; and section portions contained within the housing, each comprising a spiral-wound heater. The spiral-wound heaters together comprise a catalyst-disk stack.

### CROSS-REFERENCE TO RELATED APPLICATION

This application claims the benefit of Provisional Application No. 61/472,990, filed Apr. 7, 2011.

### TECHNICAL FIELD

The current application is directed to chemical reactors and, in particular, to a sectioned packed bed reactor with integral heating for the removal of hydrogen from a liquid organic carrier.

### BACKGROUND

Packed bed reactors have been around for many years. Packed bed reactors can be used for chemical endothermic reactions and have an inherent problem of getting the heat inside the bed catalyst. In other designs, the heat desired for the reaction to move forward should come from the outside walls of the packed bed reactor vessel or in preheating the gas or liquid prior to introduction to the catalyst. Heat moves from the side walls through conduction though the packing catalyst. This causes the bed to have a temperature gradient across the bed catalyst. This temperature gradient can be large as the mass transport through the bed removes the heat.

### SUMMARY

The current application is directed to a packed-bed reactor comprising a housing; and section portions contained within the housing, each comprising a spiral wound heater. The spiral-wound heaters together comprise a catalyst-disk stack.

### BRIEF DESCRIPTION OF THE DRAWINGS

FIG. 1 shows a spiral wound resistive heating wire that represents one example.

FIG. 2 shows a heater element embedded within catalyst that represents one example.

FIG. 3 shows a section of 3 disks in a reactor that represents one example.

FIG. 4 shows a cut-away view of 3 sections of reactor that represents one example.

### DETAILED DESCRIPTION

The proposed packed-bed reactor first sections portions of a reactor bed into thin packed catalyst disks. Each section has embedded within it a spiral wound heater. This heater provides the necessary heat to move the reaction forward while still maintaining a uniform temperature without a steep thermal gradient. Sections of catalyst disks can be stacked in series for various reactions as desired. Reacted products can be removed from the device between sections.

### The Heating Element

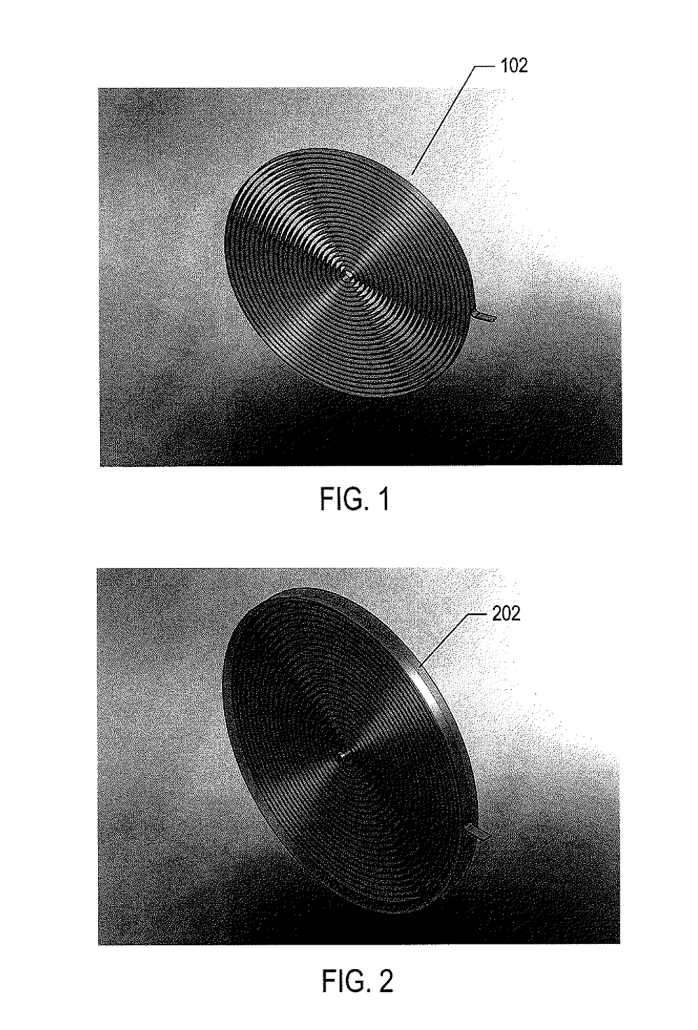

In this design, the heating element is wound as a spiral. The pitch of the spiral 102 or space between windings is set so that the heat transfer into the catalyst between the windings will have a low thermal gradient, as shown in FIG. 1.

### The Catalyst Disk Core

One end of the resistive wire is welded to a center conducting rod. The welding can be by spot welding, arc welding or other welding mechanisms. The position of the rod and length of the rod are determined by the specific catalyst disk design. In the example reactor the rod is centered on the width of the catalyst disk. The diameter of the rod is determined by the total ampacity used in the final reactor design when all catalyst disks are assembled and run at the reactor operating temperature. The resistance wire is wound around the rod. The pitch or spacing between adjacent windings in the spiral is determined by the desired watt density of the heating element. This watt density is determined by CFD (Computational Fluidic Dynamics) of mass flow through the catalyst disk. In our example, the pitch is 0.071″ with 25 turns. The width of each catalyst disk sections, is determined by the kinetics of the reaction. If the removal of heat energy from the catalyst is below the heat contributed by the heating elements to make the desired reaction go forward, then that reaction length determines the width of that catalyst disk core section. In other words, the width of the catalyst disk is governed by how much heat is removed from the catalyst heating element. Since various molecules have different heat capacities, this length can be calculated for a specific reaction and catalyst reaction length.

The length of spiral wound resistance wire is measured for resistivity to determine a baseline resistance. To prevent the spiral heating element from electrically shorting to adjacent windings due to the conductivity of the working catalyst metal, the heating element is first electrolessly plated with the working catalyst. The plating thickness is thin enough to not prevent the spiral form from losing shape or flaking off the underlying resistive wire. Once plated, the spiral resistance wire resistance should go to a very low value close to zero ohms indicating the plating is continuous along the length of the spiral. The metallic plating in essence shorts out the resistance wire. The resistance wire with the plated catalyst is then oxidized in an oxygen furnace for a pre-determined time and temperature so the catalyst becomes an oxide layer and non-electrically conductive. The oxide insulated resistive wire is then sandwiched within the working catalyst powder. In one example, pressure and heat are applied in such a manner to sinter the catalyst powder and form the catalyst disk 202 as in FIG. 2. The catalyst disk with the embedded resistance wire can be further oxidized if desired for a specific reaction. In yet another example the disk core can be encapsulated in a fine wire mesh to retain the final shape of the disk core if it is so desired.

Different catalyst disk sections can be set up to operate at different temperatures by changing either of the width, length, and or thickness of the resistance wire or the type of resistance wire. The resistance per linear foot will change the temperature for the given input power source. Each catalytic disk can also have a different bulk catalyst sandwiched between the adjacent windings.

### The Catalyst Disk Stack

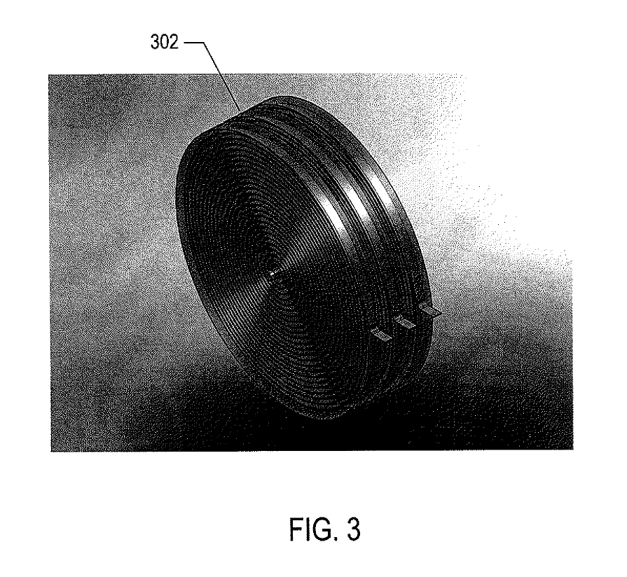

In some cases, the catalyst disk width might be a certain length to produce a given reaction at a specific temperature and flow rate. The output from that catalyst disk section might then feed another catalyst disk section 302, as in FIG. 3, which has a different reaction temperature and reaction length or even a different catalyst. It might also require the addition of another molecule before entering the second or even the third catalyst section to react with the output from previous catalyst disk sections. Disk sections might also have non reactive spacers with them. This might provide for extraction of intermediate reactant within the reactor.

### Housing

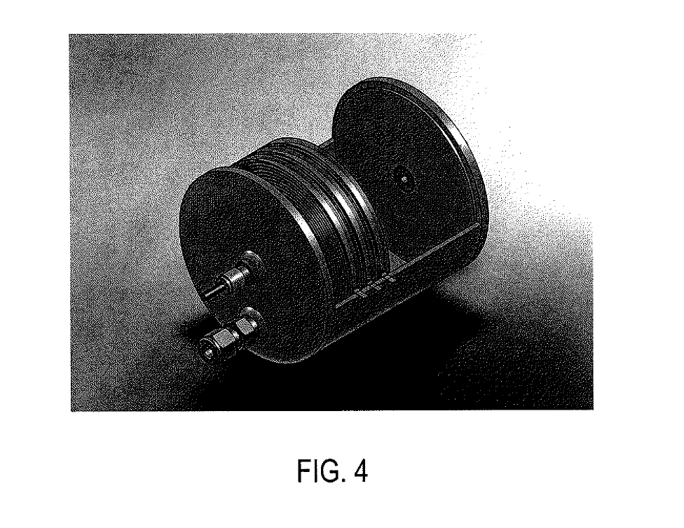

FIG. 4 shows a cut away view of a section of the catalyst disks 401-403 aligned within an outer housing 404. Electrical contact to the resistive wire within the catalyst disks is made by the center conductor rod and the outer diameter exposed resistance wire. The center rod is connected to an electrically insulated feed through either by welding or other means so as not to degrade over time and when exposed to varying temperatures and to the reactants. The outer diameter exposed resistance wire is welded to the outer reactor housing thus providing for the second current carrier path. This outer conductor path should have a low potential with respect to the center conductor and should also have a low potential to other surrounding metallic objects and surfaces. If desired, the reactor can be electrically insulated to provide for the potential voltages desired in driving the reactor heaters. Exterior band heaters (not shown) are placed around the outer circumference of the reactor housing. These heaters provide the greater bulk heat desired within the reactor itself. Exhaust gases from combustion reactions can also be used to provide bulk heating for the reactor.

### Temperature Sensing

Thermocouples are placed at various locations within the reactor. The thermocouple wires are fed though insulated feed-thoughs to the outside of the reactor and connected to controllers. The controllers, through PID loops or Fuzzy Logic determine the rate at which power should be applied to the heaters.

### Operation

Reactant, in the current case fuel, enters at the influent end of the reactor as vapor through a connector. The temperature of the vapor is such that the expanding volume behind the entrance fitting and in front of the first reactor catalyst disk does not condense the fuel. There can also be a diffusion or distributor disk or other material such as glass wool placed in front of the catalyst disks such that the distribution of reactant is uniform over the face of the disk. This provides a constant and uniform mass flow through the reactor.

As mass flows through each catalyst section, it comes in contact with the catalyst surfaces and reacts accordingly. As the mass of unreacted material moves from core to core volume of the reacted material and by products can be withdrawn from the reactor between the cores. At the effluent end of the reactor, unreacted material, by product, and reacted material exit the reactor via a connector.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A packed-bed reactor comprising:
a housing; and
section portions contained within the housing, each comprising a spiral wound heater.
